(19) United States
(12) Patent Application Publication
(10) Pub. No.: US 2023/0020877 A1
(43) Pub. Date: Jan. 19, 2023

(54) SYSTEM AND METHOD FOR DYNAMICALLY IDENTIFYING CHANGE IN CUSTOMER BEHAVIOUR AND PROVIDING APPROPRIATE PERSONALIZED RECOMMENDATIONS

(71) Applicant: Wipro Limited, Bangalore (IN)

(72) Inventors: Manoj MADHUSUDHANAN, Bangalore (IN); Sreekumar CHOYARMADATHIL, Bangalore (IN); Rohan MADHUSUDHANAN, Bangalore (IN); Lokesh SHARMA, Bangalore (IN)

(21) Appl. No.: 17/471,630

(22) Filed: Sep. 10, 2021

(30) Foreign Application Priority Data
Jul. 19, 2021 (IN) 202141032405

(51) Int. Cl. G06Q 30/06; G06Q 30/02; G06N 3/08

(52) U.S. Cl. CPC G06Q 30/0631; G06Q 30/0282; G06N 3/08

(57) ABSTRACT

This disclosure relates to method and system for dynamically identifying change in customer behaviour and providing appropriate personalized recommendations. The method includes, for each of a plurality of transactions and for each of one or more customers, generating customer behaviour data based on customer transaction data and pre-defined product segmentation data; generating a state-action-reward pair based on customer transaction data and the pre-defined product segmentation data; and generating state-behaviour mapping data based on customer behaviour data and the state-action-reward pair. The method further includes training an artificial neural network (ANN) based recommendation model based on the state-behaviour mapping data; predicting a ranked list of next state-action pairs for a target customer, based on current state of target customer and current customer behaviour data for target customer, using the ANN based recommendation model; providing one or more personalized recommendations to target customer based on the ranked list of next state-action pairs.

### TECHNICAL FIELD

This disclosure relates generally to Artificial Intelligence (AI)-based personalization, and more particularly to system and method for dynamically identifying change in customer behaviour and providing appropriate personalized recommendations.

### BACKGROUND

Analyzing ever changing customer behaviour is becoming a necessity to increase business value for companies. Today, customer behaviour is studied for proposing a recommendation to a customer. The recommendation is based on a number of one-time factors (such as, purchase history). In present state of art, change in customer behaviour over time is not captured, leading to wrong assessment of customer behaviour which, in turn, may lead to irrelevant recommendations.

With recent rise in interest in data economy, more companies are shifting towards providing personalized data-driven services. Particularly, companies in Banking, Financial Services, and insurance (BFSI) and retail sectors aim at maximizing profits through data collection via various engagements with customers. Such engagements are aimed at contextualizing business offerings based on customer context and portfolio objectives. However, businesses often miss out in identifying key context of a customer due to changing behaviour of the customer over time and generally provide recommendations that are non-relevant with respect to a drift in customer behaviour.

Further, companies may target some of focused products for which relationship managers need to identify optimal sets of customers to recommend in order to achieve a target. However, due to failure in identifying the changing behaviour of the customer, a relationship manager may miss focusing on the optimal sets of customers potentially leading to lost business opportunities and significant company losses.

In the present state of art, personalized recommendations are based on predefined life events and, therefore, for each predefined life event, a new model is required to be generated based on a sample group of consumer data associated with life events. However, such techniques are computationally complex and the personalized recommendations deviate from change in the customer behaviour. Conventional techniques capture customer behaviour patterns for a task based on behaviour of other similar and dissimilar customers for the task. However, such techniques fail to consider change in customer behaviour with time and hence, fail to provide personalized recommendations to the customer.

There is therefore a need in the present state of art for methods and systems to provide a context-based personalized recommendations to target customers based on real-time behaviour changes.

### SUMMARY

In one embodiment, a method of dynamically identifying change in customer behaviour and providing appropriate personalized recommendations is disclosed. In one example, the method includes generating customer behaviour data for each of a plurality of transactions and for each of one or more customers, based on customer transaction data and pre-defined product segmentation data. The method further includes generating a state-action-reward pair for each of the plurality of transactions and for each of one or more customers, based on the customer transaction data and the pre-defined product segmentation data. The method further includes generating state-behaviour mapping data based on the customer behaviour data and the state-action-reward pair for each of the plurality of transactions and for each of one or more customers. The state-behaviour mapping data includes a plurality of historical state-action-reward pairs, a current state, and a current customer behaviour data for each of the one or more customers. The method further includes training an artificial neural network (ANN) based recommendation model based on the state-behaviour mapping data. Training includes predicting one or more future state-action pairs by maximizing reward for each of the plurality of historical state-action pairs. The method further includes predicting a ranked list of next state-action pairs for a target customer based on the current state of the target customer and the current customer behaviour data using the ANN based recommendation model. The method further includes providing one or more personalized recommendations to the target customer based on the ranked list of next state-action pairs.

In one embodiment, a system for dynamically identifying change in customer behaviour and providing appropriate personalized recommendations is disclosed. In one example, the system includes a processor and a computer-readable medium communicatively coupled to the processor. The computer-readable medium store processor-executable instructions, which, on execution, cause the processor to generate customer behaviour data for each of a plurality of transactions and for each of one or more customers, based on customer transaction data and pre-defined product segmentation data. The processor-executable instructions, on execution, further cause the processor to generate a state-action-reward pair for each of the plurality of transactions and for each of one or more customers, based on the customer transaction data and the pre-defined product segmentation data. The processor-executable instructions, on execution, further cause the processor to generate state-behaviour mapping data based on the customer behaviour data and the state-action-reward pair for each of the plurality of transactions and for each of one or more customers. The state-behaviour mapping data includes a plurality of historical state-action-reward pairs, a current state, and a current customer behaviour data for each of the one or more customers. The processor-executable instructions, on execution, further cause the processor to train an artificial neural network (ANN) based recommendation model based on the state-behaviour mapping data. Training includes predicting one or more future state-action pairs by maximizing reward for each of the plurality of historical state-action pairs. The processor-executable instructions, on execution, further cause the processor to predict a ranked list of next state-action pairs for a target customer, based on the current state of the target customer and the current customer behaviour data for the target customer, using the ANN based recommendation model. The processor-executable instructions, on execution, further cause the processor to provide one or more personalized recommendations to the target customer based on the ranked list of next state-action pairs.

In one embodiment, a non-transitory computer-readable medium storing computer-executable instructions for dynamically identifying change in customer behaviour and providing appropriate personalized recommendations is disclosed. In one example, the stored instructions, when executed by a processor, causes the processor to perform operations including generating customer behaviour data for each of a plurality of transactions and for each of one or more customers, based on customer transaction data and pre-defined product segmentation data. The operations further include generating a state-action-reward pair for each of the plurality of transactions and for each of one or more customers, based on the customer transaction data and the pre-defined product segmentation data. The operations further include generating state-behaviour mapping data based on the customer behaviour data and the state-action-reward pair for each of the plurality of transactions and for each of one or more customers. The state-behaviour mapping data includes a plurality of historical state-action-reward pairs, a current state, and a current customer behaviour data for each of the one or more customers. The operations further include training an ANN based recommendation model based on the state-behaviour mapping data. Training includes predicting one or more future state-action pairs by maximizing reward for each of the plurality of historical state-action pairs. The operations further include predicting a ranked list of next state-action pairs for a target customer, based on the current state of the target customer and the current customer behaviour data for the target customer, using the ANN based recommendation model. The operations further include providing one or more personalized recommendations to the target customer based on the ranked list of next state-action pairs.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for dynamically identifying change in customer behaviour and providing appropriate personalized recommendations, in accordance with some embodiments of the present disclosure.

FIG. 2 is a functional block diagram of a recommendation system implemented by the exemplary system of FIG. 1, in accordance with some embodiments of the present disclosure.

FIGS. 3A and 3B illustrate a flow diagram of an exemplary process for dynamically identifying change in customer behaviour and providing appropriate personalized recommendations, in accordance with some embodiments of the present disclosure.

FIG. 4 is a flow diagram of a detailed exemplary process for dynamically identifying change in customer behaviour and providing appropriate personalized recommendations, in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

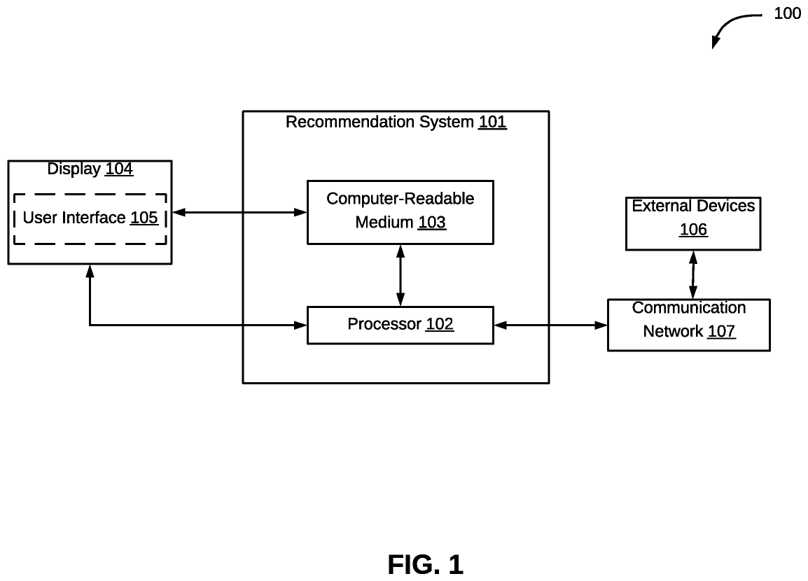

Referring now to FIG. 1, an exemplary system 100 for dynamically identifying change in customer behaviour and providing appropriate personalized recommendations is illustrated, in accordance with some embodiments of the present disclosure. The system 100 may dynamically identify change in customer behaviour and provide appropriate personalized recommendations. In particular, the system 100 may include a recommendation system 101 (for example, one or more of servers, desktops, laptops, notebooks, netbooks, tablets, smartphones, mobile phones, any other computing devices, or a combination thereof). It should be noted that, in some embodiments, the recommendation system 101 may predict a ranked list of next state-action pairs based on a current state of customer and a current customer behaviour data using an Artificial Neural Network (ANN) based recommendation model. Further, the recommendation system 101 may generate personalized recommendations for one or more customers based on the ranked list of next state-action pairs.

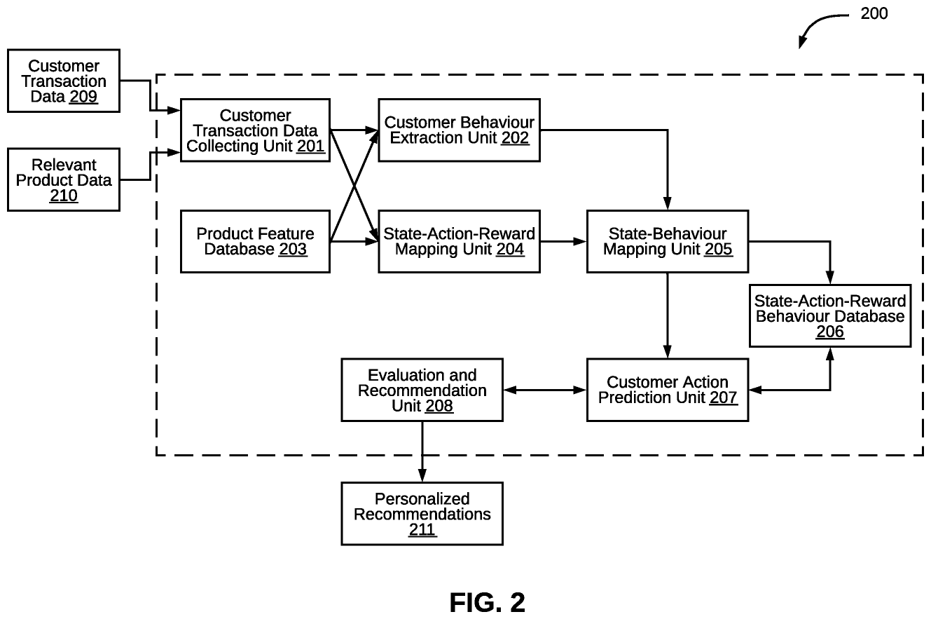

As will be described in greater detail in conjunction with FIGS. 2-4, the recommendation system may generate customer behaviour data for each of a plurality of transactions and for each of one or more customers, based on customer transaction data and pre-defined product segmentation data. The recommendation system may further generate a state-action-reward pair for each of the plurality of transactions and for each of one or more customers, based on the customer transaction data and the pre-defined product segmentation data. The recommendation system may further generate state-behaviour mapping data based on the customer behaviour data and the state-action-reward pair for each of the plurality of transactions and for each of one or more customers. The state-behaviour mapping data includes a plurality of historical state-action-reward pairs, a current state, and a current customer behaviour data for each of the one or more customers. The recommendation system may further train an artificial neural network (ANN) based recommendation model based on the state-behaviour mapping data. Training includes predicting one or more future state-action pairs by maximizing reward for each of the plurality of historical state-action pairs. The recommendation system may further predict a ranked list of next state-action pairs for a target customer, based on the current state of the target customer and the current customer behaviour data for the target customer, using the ANN based recommendation model. The recommendation system may further provide one or more personalized recommendations to the target customer based on the ranked list of next state-action pairs.

In some embodiments, the recommendation system 101 may include one or more processors 102 and a computer-readable medium 103 (for example, a memory). Further, the computer-readable storage medium 103 may store instructions that, when executed by the one or more processors 102, cause the one or more processors 102 to dynamically identify change in customer behaviour and provide appropriate personalized recommendations, in accordance with aspects of the present disclosure. The computer-readable storage medium 103 may also store various data (for example, customer behaviour data for each of a plurality of transactions, customer transaction data, pre-defined product segmentation data, ANN data, state to behaviour mapping data, personalized recommendations for customers, and the like) that may be captured, processed, and/or required by the system 100.

The system 100 may further include a display 104. The system 100 may interact with a user via a user interface 105 accessible via the display 104. The system 100 may also include one or more external devices 106. In some embodiments, the security management system 101 may interact with the one or more external devices 106 over a communication network 107 for sending or receiving various data. The external devices 106 may include, but may not be limited to, a remote server, a digital device, or another computing system.

Referring now to FIG. 2, a functional block diagram of a recommendation system 200 (analogous to the recommendation system 101 implemented by the system 100) is illustrated, in accordance with some embodiments of the present disclosure. The recommendation system 200 includes a customer transaction data collection unit 201, a customer behaviour extraction unit 202, a product feature database 203, a state-action-reward pair mapping unit 204, a state-behaviour mapping unit 205, a state-action-reward-behaviour database 206, a customer action prediction unit 207, and an evaluation and recommendation unit 208.

The customer transaction data collection unit 201 extracts customer transaction data 209 associated with a plurality of transactions corresponding to a customer. The customer transaction data 209 includes at least one of implicit data associated with a customer and explicit data associated with the customer. The implicit data includes data related to customer activities such as buying, selling, or holding products along with a time stamp. The explicit data includes data provided explicitly by customers, such as, but not limited to product ratings, reviews, likes, product subscriptions, etc. In an embodiment, customers may provide explicit data as a feedback corresponding to a business (for example, product rating and review).

Further the customer transaction data collection unit 201 extracts product segmentation data 210. The product segmentation data 210 is related to products that are on high priority for a business and are more likely to influence customer behaviour. The product segmentation data 210 impacts the implicit and the explicit data and, therefore, brings a change in the customer behaviour. By way of an example, the product segmentation data 210 may include a list of 500 prioritized products of a business out of a total list of 5000 products of the business.

Further, the customer transaction data collection unit 201 filters the customer transaction data 209 based on the product segmentation data 210 to generate filtered customer transaction data. As will be appreciated, the filtered customer transaction data is required to limit customer behaviour inference determination using focused and prioritized data.

The product feature database 203 is a database associated with product specific details. The product feature database 203 stores pre-defined product segmentation data. The product feature database 203 stores various categories of products related to the business along with product specific features. By way of an example, for a mutual fund, product information (such as, fund name, category, legal type, return in years, rating, sales, etc.) is stored as pre-defined product segmentation data in the product feature database 203.

The customer behaviour extraction unit 202 receives the filtered customer transaction data from the customer transaction data collection unit 201. Additionally, the customer behaviour extraction unit 202 receives the pre-defined product segmentation data from the product feature database 203. Further, the customer behaviour extraction unit 202 extracts customer behaviour data for each of the plurality of transactions based on the filtered customer transaction data and the pre-defined product segmentation data. The customer behaviour extraction unit 202 processes the filtered customer transaction data for each of the plurality of transactions including buying and selling of products to create a customer to product map. Further, the customer behaviour extraction unit 202 processes the pre-defined product segmentation data for each of the plurality of transactions including buying and selling of the products to create a product to feature map.

Further, the customer behaviour extraction unit 202 processes the customer to product map and the product to feature map for each of the plurality of transactions including buying and selling of the products to obtain a customer transaction to product feature map representing the customer behaviour data for each of the plurality of transactions. The customer transaction to product feature map may be considered as a representation of customer behaviour because a customer product portfolio at any point of time is a reflection of the customer behaviour.

The state-action-reward pair mapping unit 204 identifies state-action-reward pair for each of the plurality of transactions based on the filtered customer transaction data and the pre-defined product segmentation data. It may be noted that “state” refers to a position of products for a customer at any given point of time. It may also be noted that “action” refers to a possible set of activities that may be performed by a customer. Action is responsible for transitioning the customer from one state to another state. For instance, BUY and SELL may be two possible set of actions that may be responsible for a change in customer state. Further, it may be noted that “reward” refers to a possible outcome of change in customer state pertaining to an action taken by the customer. Reward is referred to as a value gain or loss associated with a customer action when the customer transitions from one state to another state. By way of an example, when the customer adds a new product to an existing customer portfolio, the reward may be considered as a return associated with a new fund in a defined time period.

The state-action-reward pair mapping unit 204 receives filtered customer transaction related data from the customer transaction data collecting unit 201 and the pre-defined product segmentation data from the product feature database 203. Further, the state-action-reward pair mapping unit 204 processes the filtered customer transaction data to extract states for each customer and actions taken by the customer to transit to new states (i.e., state transition). Further, the state-action-reward pair mapping unit 204 processes the pre-defined product segmentation data to identify rewards associated with each state transition. Further, the state-action-reward pair mapping unit 204 identifies a sequence of the states (S), the actions (A) taken at each state, and the rewards (R) of each of the state transition called as a state-action-reward pair.

The state-behaviour mapping unit 205 receives the customer behaviour data from the customer behaviour extraction unit 202 and state-action-reward pair data from the state-action-reward mapping unit 204. Further, the state-behaviour mapping unit 205 identifies state-behaviour mapping using the customer behaviour data and the state-action-reward pair data. Reward is referred to as the value gain or loss associated with a customer action when the customer transitions from one state to another. Further, each of the customer state reflects a unique behaviour. For example, when the customer adds a new product P to the existing customer portfolio, the reward may be considered as the return associated with the new fund in a defined time period. For each of the plurality of transactions for the customer, the reward is mapped to a corresponding state transition. Thus, during state-behaviour mapping, reward value is associated with a new-state matrix to formulate a reward function. The state-behaviour mapping is used to build customer segmentation. Further, the state-behaviour mapping unit 205 sends state-behaviour mapping data to the customer action prediction unit 207 and to the state-action-reward-behaviour database 206.

The customer action prediction unit 207 receives the state-behaviour mapping data from the state-behaviour mapping unit 205 and historical state-behaviour mapping data and their corresponding predicted customer actions through the state-action-reward-behaviour database 206. The customer action prediction unit 207 builds deep neural network to identify optimal hyper-parameters to capture hidden patterns and unexpected future behaviour of customers. Further, the hidden patterns and unexpected future behaviour of customers may be utilized to predict future customer behaviour by maximizing the rewards at each customer state or action.

During initial training, the customer action prediction unit 207 fetches historically calculated customer behaviour and various neural network models and corresponding parameter values to predict customer action. Upon training the various neural network models, an optimal model is selected and processed for deployment purpose. Further, the customer action prediction unit 207 predicts customer behaviour change based on an input provided to the optimal model which includes current customer behaviour and current state of the customer.

Output of the optimal model is a reward vector corresponding to each state-action pair from a trained neural network. Thus, a matrix corresponding to state-action pairs is generated. The matrix corresponding to the state-action pairs provides a score for each of the state-action pairs. The state-action pairs are ranked based on the score value. Further, a ranked list of next state and action is predicted referring to an action pointing to the next state.

The state-action-reward-behaviour database 206 stores state-behaviour mapping data received from the state-behaviour mapping unit 205. The state-action-reward-behaviour database 206 also stores predicted customer state and action from the customer action prediction unit 207. During model training, the state-action-reward-behaviour database 206 provides hyper-parameters used to capture hidden patterns and unexpected future behaviour of customers.

The evaluation and recommendation unit 208 receives the ranked list of next state and action from the customer action prediction unit 207. The evaluation and recommendation unit 208 generates personalized recommendations 211 for the customers based on the ranked list of next state and action. Further, the evaluation and recommendation unit 208 evaluates the generated personalized recommendations 211 for the customers based on a predefined set of business criteria or rules. Evaluation may be performed based on a change in state of the customer reflecting a change in customer behaviour. When the change in customer behaviour fulfils the predefined set of business criteria or rules, the evaluation is successful and the personalized recommendations 211 are provided to the customers. Further, when the change in behaviour does not fulfil the predefined set of business criteria or rules, the evaluation is unsuccessful. Deviation between the actual behaviour pattern and expected behaviour pattern is identified and is provided as a feedback to retrain the neural network models. Further, the evaluation and recommendation unit 208 outputs the personalized recommendations 211.

It should be noted that all such aforementioned modules 201-208 may be represented as a single module or a combination of different modules. Further, as will be appreciated by those skilled in the art, each of the modules 201-208 may reside, in whole or in parts, on one device or multiple devices in communication with each other. In some embodiments, each of the modules 201-208 may be implemented as dedicated hardware circuit comprising custom application-specific integrated circuit (ASIC) or gate arrays, off-the-shelf semiconductors such as logic chips, transistors, or other discrete components. Each of the modules 201-208 may also be implemented in a programmable hardware device such as a field programmable gate array (FPGA), programmable array logic, programmable logic device, and so forth. Alternatively, each of the modules 201-208 may be implemented in software for execution by various types of processors (e.g., processor 102). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for dynamically identifying change in customer behaviour and providing appropriate personalized recommendations. For example, the exemplary system 100 and the associated recommendation system 101, 200 may establish secure communication channels between hybrid resources by the processes discussed herein. In particular, as will be appreciated by those of ordinary skill in the art, control logic and/or automated routines for performing the techniques and steps described herein may be implemented by the system 100 and the associated recommendation system 101, 200 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

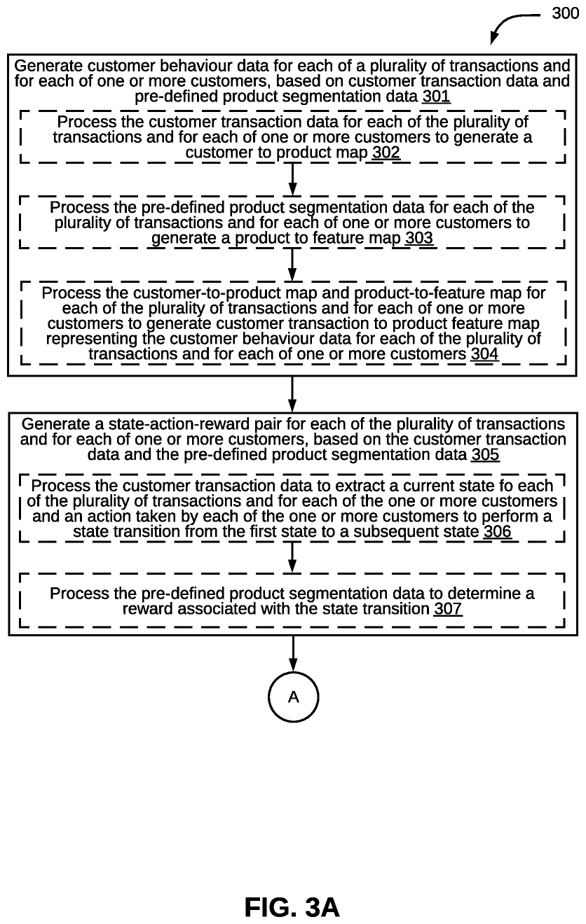

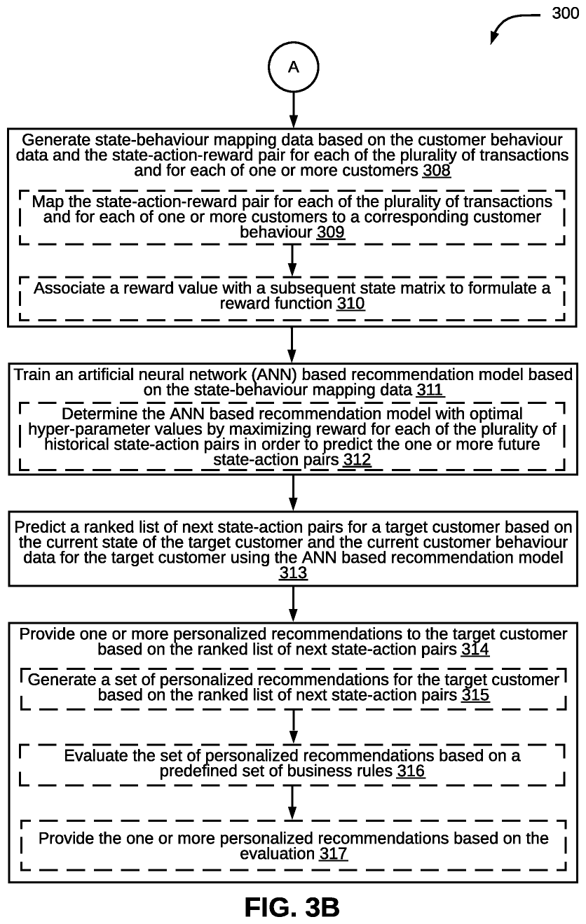

Referring now to FIGS. 3A and 3B, an exemplary process 300 for dynamically identifying change in customer behaviour and providing appropriate personalized recommendations is depicted via a flowchart, in accordance with some embodiments of the present disclosure. In an embodiment, the process 300 may be implemented by the recommendation system 101. The process 300 includes generating customer behaviour data for each of a plurality of transactions and for each of one or more customers, based on customer transaction data and pre-defined product segmentation data, at step 301. In an embodiment, the process 300 may include acquiring the customer transaction data prior to generating the customer behaviour data. The customer transaction data includes timestamped transaction data related to each of the plurality of transactions and to each of the one or more customers with respect to each of one or more products, and product feedback data provided by each of the one or more customers with respect to each of the one or more products. In an embodiment, the process 300 includes filtering the customer transaction data based on relevant product data to generate filtered customer transaction data. The relevant product data correspond to a set of priority products.

Further, the step 301 of the process 300 includes processing the customer transaction data for each of the plurality of transactions and for each of one or more customers to generate a customer to product map, at step 302. Further, the step 301 of the process 300 includes processing the pre-defined product segmentation data for each of the plurality of transactions and for each of one or more customers to generate a product to feature map, at step 303. Further, the step 301 of the process 300 includes processing the customer-to-product map and product-to-feature map for each of the plurality of transactions and for each of one or more customers to generate customer transaction to product feature map representing the customer behaviour data for each of the plurality of transactions and for each of one or more customers, at step 304.

Further, the process 300 includes generating a state-action-reward pair for each of the plurality of transactions and for each of one or more customers, based on the customer transaction data and the pre-defined product segmentation data, at step 305. Further, the step 305 of the process 300 includes processing the customer transaction data to extract a first state for each of the plurality of transactions and for each of the one or more customers and an action taken by each of the one or more customers to perform a state transition from the first state to a subsequent state, at step 306. Further, the step 305 of the process 300 includes processing the pre-defined product segmentation data to determine a reward associated with the state transition, at step 307.

Further, the process 300 includes generating state-behaviour mapping data based on the customer behaviour data and the state-action-reward pair for each of the plurality of transactions and for each of one or more customers, at step 308. The state-behaviour mapping data includes a plurality of historical state-action-reward pairs, a current state, and a current customer behaviour data for each of the one or more customers. Further, the step 308 of the process 300 includes mapping the state-action-reward pair for each of the plurality of transactions and for each of one or more customers to a corresponding customer behaviour, at step 309. Further, the step 308 of the process 300 includes associating a reward value with a subsequent state matrix to formulate a reward function, at step 310.

By way of an example, for each of one or more customers, the customer transaction data collecting unit 201 acquires the customer transaction data 209 and the relevant product data 210. Further, the customer transaction data collecting unit 201 filters the customer transaction data 209 based on the relevant product data 210 to generate filtered customer transaction data. Further, the customer transaction data collecting unit 201 sends the filtered customer transaction data to the customer behaviour extraction unit 202 and the state-action-reward mapping unit 204. The customer behaviour extraction unit 202 generates customer behaviour data for each of the filtered customer transaction data. Further, the customer behaviour extraction unit 202 sends the customer behaviour data to the state-behaviour mapping unit 205. The state-action-reward mapping unit 204 generates a state-action-reward pair for each of the filtered customer transaction data. Further, the state-action-reward mapping unit 204 sends the state-action-reward pair for each of the filtered customer transaction data to the state-behaviour mapping unit 205. The state-behaviour mapping unit 205 generates state-behaviour mapping data based on the customer behaviour data and the state-action-reward pair for each of the filtered customer transaction data. The state-behaviour mapping data is stored in the state-action-reward behaviour database 206.

Further, the process 300 includes training an ANN based recommendation model based on the state-behaviour mapping data, at step 311. Training includes predicting one or more future state-action pairs by maximizing reward for each of the plurality of historical state-action pairs. Further, the step 311 of the process 300 includes determining the ANN based recommendation model with optimal hyper-parameter values by maximizing reward for each of the plurality of historical state-action pairs in order to predict the one or more future state-action pairs, at step 312. Further, the process 300 includes predicting a ranked list of next state-action pairs for a target customer, based on the current state of the target customer and the current customer behaviour data for the target customer, using the ANN based recommendation model, at step 313.

Further, the process 300 includes providing one or more personalized recommendations to the target customer based on the ranked list of next state-action pairs, at step 314. Further, the step 314 of the process 300 includes generating a set of personalized recommendations for the target customer based on the ranked list of next state-action pairs, at step 315. Further, the step 314 of the process 300 includes evaluating the set of personalized recommendations based on a predefined set of business rules, at step 316. Further, the step 314 of the process 300 includes providing the one or more personalized recommendations based on the evaluation, at step 317.

In continuation of the example above, the state-behaviour mapping unit 205 and the state-action-reward behaviour database 206 send the state-behaviour mapping data to the customer action prediction unit 207. The customer action prediction unit 207 includes an ANN based recommendation model which is trained based on the state-behaviour mapping data. The customer action prediction unit 207 predicts one or more future state-action pairs by maximizing reward for each of the plurality of historical state-action pairs. Further, the customer action prediction unit 207 predicts a ranked list of next state-action pairs for a target customer, based on the current state of the target customer and the current customer behaviour data for the target customer, using the ANN based recommendation model. Further, the customer action prediction unit 207 sends the ranked list of next state-action pairs for the target customer to the evaluation and recommendation unit 208. The evaluation and recommendation unit 208 provides personalized recommendations 211 to the target customer based on the ranked list of next state-action pairs.

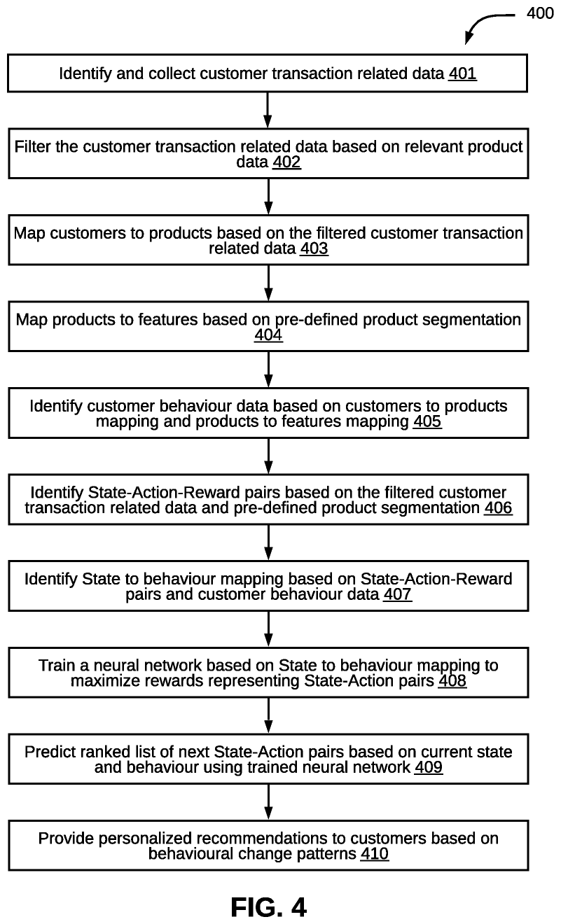

Referring now to FIG. 4, a detailed exemplary process 400 for dynamically identifying change in customer behaviour and providing appropriate personalized recommendations is depicted via a flowchart, in accordance with some embodiments of the present disclosure. In an embodiment, the process 400 may be implemented by the recommendation system 101. The process 400 includes identifying and collecting customer transaction data, at step 401. Customer transaction data 209, generated based on various customer activities related to products, is identified and collected. The customer transaction data collecting unit 201 identifies and collects implicit data related to customer activities such as patterns of buying and selling associated with products along with time stamps. Additionally, the customer transaction data collecting unit 201 identifies and collects explicit data provided by customers such as product ratings, reviews, likes, and product subscriptions, etc. In an embodiment, explicit data is provided by customer as a feedback to a business (for example, product rating and reviews).

Further, the process 400 includes filtering the customer transaction related data based on relevant product data, at step 402. The customer transaction data collecting unit 201 filters out customer transaction data based on relevant product data. The customer transaction data collecting unit 201 filters out the customer transaction data 209 using a list of products in the relevant product data so as to limit customer behaviour inference determination using focused and prioritized data in subsequent steps of the process 400.

Relevant product data includes data related to high priority products for the business which are more likely to influence customer behaviour. Relevant product data impacts the implicit data and the explicit data and, therefore, brings a change in the customer behaviour. By way of an example, relevant data may include a list of 500 prioritized products for a business out of a total list of 5000 products of the business.

Further, the process 400 includes mapping customers to products based on the filtered customer transaction data, at step 403. The customer behaviour extraction unit 202 creates a matrix representing a relation between the customers and the products based on the filtered customer transaction data. The customer behaviour extraction unit 202 processes the filtered customer transaction data for each of the plurality of transactions including buying and selling of the products to create a customer to product map, received from the customer transaction data collecting unit 201.

Further, the process 400 includes mapping products to features based on pre-defined product segmentation, at step 404. The customer behaviour extraction unit 202 creates a matrix representing a relation between features or specifications and the products based on pre-defined product segmentation data provided by the product feature database 203. The customer behaviour extraction unit 202 processes the pre-defined product segmentation data for each of the plurality of transactions including buying and selling of the products to create a product to feature map.

By way of an example, for a mutual fund, product information such as fund name, category, legal type, and return in years, rating, sales etc. would be provided as the pre-defined product segmentation data by the business. When a customer buys or sells the product, based on the pre-defined product segmentation data, the customer behaviour extraction unit 202 creates a map between the mutual fund product and corresponding features or specifications.

Further, the process 400 includes identifying customer behaviour data based on customers to products mapping and products to features mapping, at step 405. The customer behaviour extraction unit 202 identifies customer behaviour for each of the plurality of transactions. The customer behaviour extraction unit 202 processes the customer to product map and the product to feature map for each of the plurality of transactions including buying and selling of the products to obtain a customer transaction to product feature map representing the customer behaviour data for each of the plurality of transactions.

Further, the process 400 includes identifying state-action-reward pairs based on the filtered customer transaction data and the pre-defined product segmentation data, at step 406. The customer behaviour for an individual customer is defined in terms of three aspects based on customer activities: state, action, and rewards.

State refers to position of the products for a customer at any given point of time.

S:[S0,S1,S2,S3, . . . ,St] (1)

Where S0, S1, S2, . . . are the states and Sₜ is the current state.

Action refers to a possible set of activities that may be performed by a customer. It may be noted that action is responsible for transitioning customer from one state to another state. For instance, BUY and SELL may be two possible set of actions which may be responsible for a change in customer state.

A:[A0,A1,A2,A3, . . . ,An] (2)

Where A0, A1, A2, . . . are possible set of actions

Reward refers to a possible outcome of change in customer state pertaining to action taken by the customer. Reward is referred to as a value gain or loss associated with customer action when customer transitions from one state to another state. By way of an example, when the customer adds a new product to existing customer portfolio, the reward may be considered as a return associated with new fund in a defined time period.

R:[R0,R1,R2,R3, . . . ,Rn] (3)

Where R0, R1, R2, . . . are possible set of Rewards

Sequence of steps, action taken at each step and reward of transitioning from each state, may be represented as:

[S0A0R0S1]

Where S0 and S1 represent previous and current state, respectively,

A0 represents action taken, and

R0 represents outcome of change in state from S0 to S1.

The state-action-reward pair mapping unit 204 processes the filtered customer transaction data to extract the states for a customer and the actions taken by the customer during state transitions (transitions from previous states to new states).

The state-action-reward pair mapping unit 204 processes the pre-defined product segmentation data to identify the reward associated with each of the state transitions. Further, the state-action-reward pair mapping unit 204 identifies the sequence of states (S), actions (A) taken at each state, and the rewards (R) of each of the state transitions, represented as:

[S0A0R0,S1A1R1,S2A2R2,S3A3R3, . . . ,SₜAₜRₜ]

Further, the process 400 includes identifying State to behaviour mapping based on State-Action-Reward pairs and customer behaviour data, at step 407. The state-behaviour mapping unit 205 maps the state-action-reward pairs received from the state-action-reward mapping unit 204 to the customer behaviour data received from the customer behaviour extraction unit 202. Each of the states for a customer reflects a unique behaviour.

Further, the state-behaviour mapping unit 205 processes the state-action-reward pairs and the customer behaviour data to map the state-action-reward pairs to the customer behaviour data to build customer segmentation which may be represented as:

[S0A0R0]:[B0]

[S1A1R1]:[B1]

[S2A2R2]:[B2]

[S3A3R3]:[B3]

[SₜAₜRₜ]:[Bₜ] (4)

Where B: [B0, B1, B2, B3, . . . , Bₜ] are the customer behaviour at each state.

Further, the process 400 includes training a neural network based on state to behaviour mapping to maximize rewards representing state-action pairs, at step 408. The customer action prediction unit 207 maximizes the reward representing the state-action pairs. It may be noted that the reward of any state is dependent on the possible set of actions (Aₜ) that may be taken to transit from current state (Sₜ) to next state (Sₜ₊₁) based on current behaviour (Bₜ) so that the reward is maximized.

The state-behaviour mapping unit 205 trains a neural network with an input, output, and loss function to maximize the reward.

It may be noted that the input to the neural network at any given point of time may be the customer behaviour (B) and the state (S) available from the customer segmentation. Number of input nodes is equivalent to the aggregation of features from the customer behaviour and the state, represented as:

Customer Behaviour: [B]_{b×1} (5)

State: [S]_{s×1} (6)

So, Input: [B S]_{(b+s)×1} (7)

The output of the neural network represents the reward function with a shape equivalent to number of state-action pairs, represented as: [Reward]_{state-action×1}

The customer action prediction unit 207 trains a neural network with customer behaviour and state change in a way to maximize the reward. In other words, a network is built to predict rewards corresponding to each possible state-action pair. Hence, the loss function may be represented as:

Loss=([Reward]_{state-action×1}−[Neural Network]_{state-action×1})² (8)

Further, the process 400 includes predicting ranked list of next State-Action pairs based on current state and behaviour using trained neural network, at step 409. The customer action prediction unit 207 predicts next state and action based on the customer current state and behaviour.

The customer action prediction unit 207 identifies the current state and behaviour from the state to behaviour mapping and sends the current state and behaviour to the trained neural network. Further, the customer action prediction unit 207 receives a reward vector output corresponding to each of the state-action pairs from the trained neural network. Further, the customer action prediction unit 207 predicts a ranked list of next state and action based on the reward vector output.

Further, the process 400 includes providing personalized recommendations to customers based on behavioural change patterns, at step 410. The evaluation and recommendation unit 208 generates personalized recommendations for the customers based on the ranked list of next state and action received from the customer action prediction unit 207. The evaluation and recommendation unit 208 evaluates the generated personalized recommendations for the customers based on a predefined set of business criteria or rules. Evaluation may be done based on the change in state of the customer reflecting a change in customer behaviour.

When the change in behaviour fulfils the predefined set of business criteria or rules, the evaluation is successful and recommendation is provided to the customers.

When the change in behaviour does not fulfil the predefined set of business criteria or rules, the evaluation is unsuccessful. Deviation between actual behaviour pattern and expected behaviour pattern is identified and is provided as a feedback to retrain the neural network.

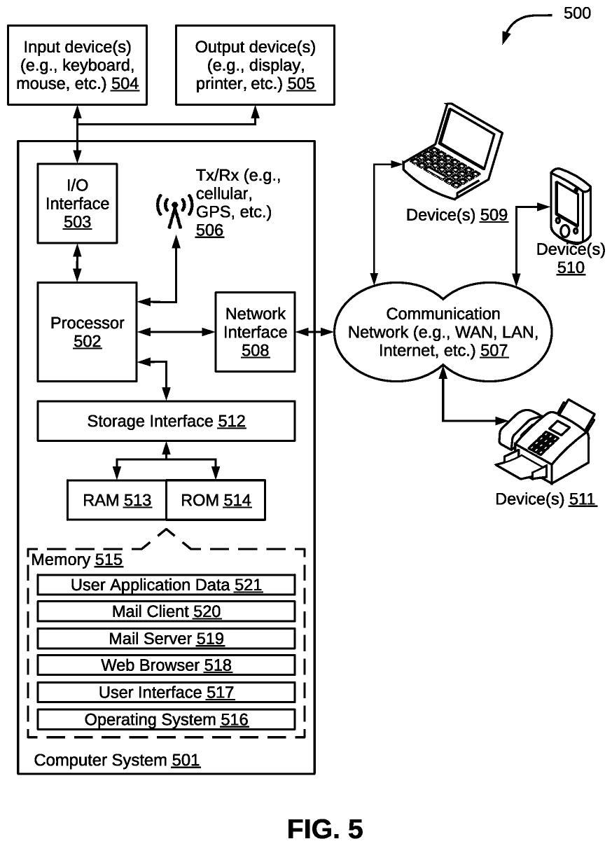

The disclosed methods and systems may be implemented on a conventional or a general-purpose computer system, such as a personal computer (PC) or server computer. Referring now to FIG. 5, a block diagram of an exemplary computer system 501 for implementing embodiments consistent with the present disclosure is illustrated. Variations of computer system 501 may be used for implementing system 100 for certificate-less security management of interconnected hybrid resources. Computer system 501 may include a central processing unit (“CPU” or “processor”) 502. Processor 502 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n /b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver 506 may facilitate various types of wireless transmission or reception. For example, the transceiver 506 may include an antenna operatively connected to a transceiver chip (e.g., TEXAS INSTRUMENTS® WILINK WL1286®, BROADCOM® BCM4550IUB8®, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 501 may implement a web browser 518 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 501 may implement a mail server 519 stored program component. The mail server may be an Internet mail server such as MICROSOFT® EXCHANGE®, or the like. The mail server may utilize facilities such as ASP, ActiveX, ANSI C++/C#, MICROSOFT .NET® CGI scripts, JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 501 may implement a mail client 520 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, computer system 501 may store user/application data 521, such as the data, variables, records, etc. (e.g., the set of predictive models, the plurality of clusters, set of parameters (batch size, number of epochs, learning rate, momentum, etc.), accuracy scores, competitiveness scores, ranks, associated categories, rewards, threshold scores, threshold time, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

Thus, the disclosed method and system try to overcome the technical problem of dynamically identifying change in customer behaviour and providing appropriate personalized recommendations. The method and system enable recommendation systems to become more personalized and aid in increasing business value. Further, the method and system use neural networks to find a state or action to obtain maximized returns. Further, the method and system enable marketing professionals to focus on identifying customer behaviour inference on specific product segments as customer data is filtered based on relevant product list.

As will be appreciated by those skilled in the art, the techniques described in the various embodiments discussed above are not routine, or conventional, or well understood in the art. The techniques discussed above provide for dynamically identifying change in customer behaviour and providing appropriate personalized recommendations. The techniques first generate customer behaviour data for each of a plurality of transactions and for each of one or more customers, based on customer transaction data and pre-defined product segmentation data. The techniques then generate a state-action-reward pair for each of the plurality of transactions and for each of one or more customers, based on the customer transaction data and the pre-defined product segmentation data. The techniques then generate state-behaviour mapping data based on the customer behaviour data and the state-action-reward pair for each of the plurality of transactions and for each of one or more customers. The state-behaviour mapping data includes a plurality of historical state-action-reward pairs, a current state, and a current customer behaviour data for each of the one or more customers. The techniques then train an artificial neural network (ANN) based recommendation model based on the state-behaviour mapping data. Training includes predicting one or more future state-action pairs by maximizing reward for each of the plurality of historical state-action pairs. The techniques then predict a ranked list of next state-action pairs for a target customer, based on the current state of the target customer and the current customer behaviour data for the target customer, using the ANN based recommendation model. The techniques then provide one or more personalized recommendations to the target customer based on the ranked list of next state-action pairs.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described system and method for dynamically identifying change in customer behaviour and providing appropriate personalized recommendations. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of dynamically identifying change in customer behaviour and providing appropriate personalized recommendations, the method comprising:
generating, by a recommendation system, customer behaviour data for each of a plurality of transactions and for each of one or more customers, based on customer transaction data and pre-defined product segmentation data;
generating, by the recommendation system, a state-action-reward pair for each of the plurality of transactions and for each of one or more customers, based on the customer transaction data and the pre-defined product segmentation data;
generating, by the recommendation system, state-behaviour mapping data based on the customer behaviour data and the state-action-reward pair for each of the plurality of transactions and for each of one or more customers, wherein the state-behaviour mapping data comprises a plurality of historical state-action-reward pairs, a current state, and a current customer behaviour data for each of the one or more customers;
training, by the recommendation system, an artificial neural network (ANN) based recommendation model based on the state-behaviour mapping data, wherein training comprises predicting one or more future state-action pairs by maximizing reward for each of the plurality of historical state-action pairs;
predicting, by the recommendation system, a ranked list of next state-action pairs for a target customer, based on the current state of the target customer and the current customer behaviour data for the target customer, using the ANN based recommendation model; and
providing, by the recommendation system, one or more personalized recommendations to the target customer based on the ranked list of next state-action pairs.

2. The method of claim 1, further comprising acquiring the customer transaction data, wherein the customer transaction data comprises:
timestamped transaction data related to each of the plurality of transactions and to each of the one or more customers with respect to each of one or more products, and
product feedback data provided by each of the one or more customers with respect to each of the one or more products.

3. The method of claim 1, further comprising filtering the customer transaction data based on relevant product data to generate filtered customer transaction data, wherein the relevant product data correspond to a set of priority products.

4. The method of claim 1, further comprising receiving the pre-defined product segmentation data, wherein the pre-defined product segmentation data comprises a categorization and a set of features with respect to each of one or more products.

5. The method of claim 1, wherein generating the customer behaviour data comprises:
processing the customer transaction data for each of the plurality of transactions and for each of one or more customers to generate a customer to product map;
processing the pre-defined product segmentation data for each of the plurality of transactions and for each of one or more customers to generate a product to feature map; and
processing the customer-to-product map and product-to-feature map for each of the plurality of transactions and for each of one or more customers to generate customer transaction to product feature map representing the customer behaviour data for each of the plurality of transactions and for each of one or more customers.

6. The method of claim 1, wherein generating the state-action-reward pair comprises:
processing the customer transaction data to extract a first state for each of the plurality of transactions and for each of the one or more customers and an action taken by each of the one or more customers to perform a state transition from the first state to a subsequent state; and
processing the pre-defined product segmentation data to determine a reward associated with the state transition.

7. The method of claim 1, wherein generating the state-behaviour mapping comprises at least one of:
mapping the state-action-reward pair for each of the plurality of transactions and for each of one or more customers to a corresponding customer behaviour; and
associating a reward value with a subsequent state matrix to formulate a reward function.

8. The method of claim 1, wherein training the ANN based recommendation model further comprises:
determining the ANN based recommendation model with optimal hyper-parameter values by maximizing reward for each of the plurality of historical state-action pairs in order to predict the one or more future state-action pairs.

9. The method of claim 1, wherein providing the one or more personalized recommendations comprises:
generating a set of personalized recommendations for the target customer based on the ranked list of next state-action pairs;
evaluating the set of personalized recommendations based on a predefined set of business rules; and
providing the one or more personalized recommendations based on the evaluation.

10. A system for dynamically identifying change in customer behaviour and providing appropriate personalized recommendations, the system comprising:
a processor; and
a memory communicatively coupled to the processor, wherein the memory stores processor instructions, which when executed by the processor, cause the processor to:
generate customer behaviour data for each of a plurality of transactions and for each of one or more customers, based on customer transaction data and pre-defined product segmentation data;
generate a state-action-reward pair for each of the plurality of transactions and for each of one or more customers, based on the customer transaction data and the pre-defined product segmentation data;
generate state-behaviour mapping data based on the customer behaviour data and the state-action-reward pair for each of the plurality of transactions and for each of one or more customers, wherein the state-behaviour mapping data comprises a plurality of historical state-action-reward pairs, a current state, and a current customer behaviour data for each of the one or more customers;
train an artificial neural network (ANN) based recommendation model based on the state-behaviour mapping data, wherein training comprises predicting one or more future state-action pairs by maximizing reward for each of the plurality of historical state-action pairs;
predict a ranked list of next state-action pairs for a target customer, based on the current state of the target customer and the current customer behaviour data for the target customer using the ANN based recommendation model; and
provide one or more personalized recommendations to the target customer based on the ranked list of next state-action pairs.

11. The system of claim 10, wherein the processor instructions, on execution, further cause the processor to acquire the customer transaction data, and wherein the customer transaction data comprises:
timestamped transaction data related to each of the plurality of transactions and to each of the one or more customers with respect to each of one or more products, and
product feedback data provided by each of the one or more customers with respect to each of the one or more products.

12. The system of claim 10, wherein the processor instructions, on execution, further cause the processor to filter the customer transaction data based on relevant product data to generate filtered customer transaction data, wherein the relevant product data correspond to a set of priority products.

13. The system of claim 10, wherein the processor instructions, on execution, further cause the processor to receive the pre-defined product segmentation data, and wherein the pre-defined product segmentation data comprises a categorization and a set of features with respect to each of one or more products.

14. The system of claim 10, wherein to generate the customer behaviour data, the processor instructions, on execution, further cause the processor to:
process the customer transaction data for each of the plurality of transactions to and for each of one or more customers generate a customer to product map;
process the pre-defined product segmentation data for each of the plurality of transactions and for each of one or more customers to generate a product to feature map; and
process the customer-to-product map and product-to-feature map for each of the plurality of transactions and for each of one or more customers to generate customer transaction to product feature map representing the customer behaviour data for each of the plurality of transactions and for each of one or more customers.

15. The system of claim 10, wherein to generate the state-action-reward pair, the processor instructions, on execution, further cause the processor to:
process the customer transaction data to extract a first state for each of the plurality of transactions and for each of the one or more customers and an action taken by each of the one or more customers to perform a state transition from the first state to a subsequent state; and
process the pre-defined product segmentation data to determine a reward associated with the state transition.

16. The system of claim 10, wherein to generate the state-behaviour mapping, the processor instructions, on execution, further cause the processor to, at least one of:
map the state-action-reward pair for each of the plurality of transactions and for each of one or more customers to a corresponding customer behaviour; and
associate a reward value with a subsequent-state matrix to formulate a reward function.

17. The system of claim 10, wherein to train the ANN based recommendation model, the processor instructions, on execution, further cause the processor to:
determine the ANN based recommendation model with optimal hyper-parameter values by maximizing reward for each of the plurality of historical state-action pairs in order to predict the one or more future state-action pairs.

18. The method of claim 1, wherein to provide the one or more personalized recommendations, the processor instructions, on execution, further cause the processor to:
generate a set of personalized recommendations for the target customer based on the ranked list of next state-action pairs;
evaluate the set of personalized recommendations based on a predefined set of business rules; and
provide the one or more personalized recommendations based on the evaluation.

19. A non-transitory computer-readable medium storing computer-executable instructions for dynamically identifying change in customer behaviour and providing appropriate personalized recommendations, the computer-executable instructions configured for:
generating customer behaviour data for each of a plurality of transactions and for each of one or more customers, based on customer transaction data and pre-defined product segmentation data;
generating a state-action-reward pair for each of the plurality of transactions and for each of one or more customers, based on the customer transaction data and the pre-defined product segmentation data;
generating state-behaviour mapping data based on the customer behaviour data and the state-action-reward pair for each of the plurality of transactions and for each of one or more customers, wherein the state-behaviour mapping data comprises a plurality of historical state-action-reward pairs, a current state, and a current customer behaviour data for each of the one or more customers;
training an artificial neural network (ANN) based recommendation model based on the state-behaviour mapping data, wherein training comprises predicting one or more future state-action pairs by maximizing reward for each of the plurality of historical state-action pairs;
predicting a ranked list of next state-action pairs for a target customer, based on the current state of the target customer and the current customer behaviour data for the target customer, using the ANN based recommendation model; and
providing one or more personalized recommendations to the target customer based on the ranked list of next state-action pairs.

20. The non-transitory computer-readable medium of claim 19, wherein to provide the one or more personalized recommendations, the computer-executable instructions are further configured for:
generating a set of personalized recommendations for the target customer based on the ranked list of next state-action pairs;
evaluating the set of personalized recommendations based on a predefined set of business rules; and
providing the one or more personalized recommendations based on the evaluation.
